(19) United States
(12) Patent Application Publication
(10) Pub. No.: US 2021/0035246 A1
(43) Pub. Date: Feb. 4, 2021

(54) INTELLECTUAL PROPERTY ASSET MANAGEMENT SYSTEM USING DISTRIBUTED LEDGER TECHNOLOGY

(71) Applicant: Intellectual Technologies PDE. LTD., Paya Lebar (SG)

(72) Inventors: Jimmy Schouppe, Geraardsbergen (BE); Mario J. Lewin, Frisco, TX (US); Jürgen Schouppe, Kortenberg (BE)

(21) Appl. No.: 16/941,229

(22) Filed: Jul. 28, 2020

Related U.S. Application Data
(60) Provisional application No. 62/880,519, filed on Jul. 30, 2019.

(51) Int. Cl. G06Q 50/18; H04L 9/32

(52) U.S. Cl. CPC G06Q 50/184; G06Q 2220/12; H04L 9/3263; H04L 9/3242

(57) ABSTRACT

This disclosure provides systems, methods, and apparatus, including computer programs encoded on computer-readable media, for managing IP assets using distributed ledger technology (DLT). An IP asset management platform or application may obtain one or more files associated with an IP asset, and process the one or more files to create a record on a distributed ledger that is associated with the IP asset, where the processing includes, at least in part, generating a hash from information associated with the one or more files and a timestamp. The IP asset management platform or application may then create the record on the distributed ledger, where the record includes at least the hash and the timestamp, and generate a blockchain certificate. The IP asset management platform or application may verify one or more utility tokens are received prior to processing the one or more files to create the record on the distributed ledger.

### CROSS-REFERENCE TO RELATED APPLICATION

This patent application claims priority to U.S. Provisional Patent Application No. 62/880,519, filed on Jul. 30, 2019. The disclosure of the prior applications is considered part of and is incorporated by reference in this patent application.

### TECHNICAL FIELD

This disclosure relates generally to the field of distributed networks, and more particularly to implementing an intellectual property asset management system using distributed ledger technology (DLT).

### DESCRIPTION OF THE RELATED TECHNOLOGY

Intellectual Property (IP) refers to creations of the mind, which include inventions, literary and artistic works, and symbols, names, images, and designs used in commerce, among others. IP is divided into two main categories. The first category is industrial property, which includes patents, utility models, trademarks, industrial designs and geographical indications of source. The second category is copyrights, which includes literary, musical, and general artistic works such as novels, poems, movies, songs, drawings, paintings, photographs, sculptures, and architectural designs. For instance, rights related to copyright may include artists and their artworks or performances, producers with their particular theme and recording, and all types of audial and visual broadcasters (e.g. podcast, radio, television, and video).

Companies and individuals that disclose their unique ideas, products, and services to the public in order to seek IP protection and commercialization take on the risk that their unique ideas, products, and services, even when protected by IP rights, could be globally infringed upon. Increased globalization and the development and growth of the Internet worldwide have made IP protection more important than ever. It is vital to maintain the integrity of IP by having laws that protect IP rights and facilitate future innovation, progression, and advancements in various industries. It is also important to use new and emerging technologies to help manage and protect IP rights.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method performed by an intellectual property (IP) asset management platform using distributed ledger technology (DLT). The method may include obtaining one or more files associated with an IP asset, and processing the one or more files to create a record on a distributed ledger that is associated with the IP asset, where the processing may include, at least in part, generating a hash from information associated with the one or more files and a timestamp. The method may include creating the record on the distributed ledger, the record including at least the hash and the timestamp.

In some implementations, the method may include generating a blockchain certificate for the IP asset after creating the record on the distributed ledger, the blockchain certificate including at least the hash and the timestamp.

In some implementations, the blockchain certificate may further include one or more of ownership information, a description of the IP asset, a thumbnail of the IP asset, and a block number associated with the record on the distributed ledger.

In some implementations, the method may include verifying one or more utility tokens are received prior to processing the one or more files to create the record on the distributed ledger.

In some implementations, the method may include generating a non-fungible token (NFT) associated with the IP asset.

In some implementations, the method may include uploading the IP asset to an IP marketplace after generating the NFT.

In some implementations, uploading the IP asset to the IP marketplace may include at least uploading the NFT associated with the IP asset to the IP marketplace.

In some implementations, the method may include listing the IP asset in the IP marketplace to be sold, traded, licensed, or auctioned.

In some implementations, the method may include pooling the IP asset with one or more additional IP assets to create an IP asset pool, and listing the IP asset pool in the IP marketplace.

In some implementations, the one or more additional IP assets have the same owner as the IP asset or one or more different owners.

In some implementations, the method may include determining fractional shares of the IP asset, and listing fractional shares of the IP asset in the IP marketplace.

In some implementations, the method may include providing an inheritance feature to the IP asset in the IP asset management platform.

In some implementations, the method may include receiving one or more utility tokens prior to processing the one or more files to create the record on the distributed ledger, processing the one or more files to create the record on the distributed ledger in response to receiving the one or more utility tokens, and implementing a fee delegation feature using, at least in part, the one or more utility tokens.

In some implementations, the method may include verifying one or more utility tokens are included in an account of the IP asset management platform associated with the IP asset prior to processing the one or more files to create the record on the distributed ledger, and processing the one or more files to create the record on the distributed ledger in response to verifying the account includes the one or more utility tokens.

In some implementations, the method may include implementing a fee delegation feature in response to verifying the account includes the one or more utility tokens.

In some implementations, the method may include providing one or more gas tokens associated with the DLT using the fee delegation feature to create the record on the distributed ledger in response to verifying the account includes the one or more utility tokens.

In some implementations, the method may include converting at least a portion of a utility token of the one or more utility tokens into one or more gas tokens associated with the DLT using the fee delegation feature to create the record on the distributed ledger in response to verifying the account includes the one or more utility tokens.

Another innovative aspect of the subject matter described in this disclosure can be implemented in a method performed by an IP asset management application being executed on a mobile device and using DLT. The method may include capturing a digital photograph using the IP asset management application that is associated with an IP asset management platform, and automatically processing one or more files associated with the captured digital photograph to create a record on a distributed ledger that is associated with the captured digital photograph, where the processing may include, at least in part, generating a hash from information associated with the one or more files and a timestamp. The method may include creating the record on the distributed ledger, the record including the hash and the timestamp.

In some implementations, the method may include, after capturing the digital photograph, automatically generating a NFT associated with the digital photograph.

In some implementations, the method may include automatically uploading the digital photograph to an IP marketplace.

In some implementations, automatically uploading the digital photograph to the IP marketplace may include at least automatically uploading the NFT associated with the digital photograph to the IP marketplace.

Another innovative aspect of the subject matter described in this disclosure can be implemented in a method performed by an IP asset management application being executed on a mobile device and using DLT. The method may include capturing a digital video using the IP asset management application that is associated with an IP asset management platform, and automatically processing one or more files associated with the captured digital video to create a record on a distributed ledger that is associated with the captured digital video, where the processing of the one or more files may include, at least in part, generating a hash from information associated with the one or more files and a timestamp. The method may include creating the record on the distributed ledger, the record including the hash and the timestamp.

In some implementations, the method may include, after capturing the digital video, automatically generating a non-fungible token (NFT) associated with the digital video.

In some implementations, the method may include automatically uploading the digital video to an IP marketplace.

In some implementations, the method may include automatically uploading the digital video to the IP marketplace includes at least automatically uploading the NFT associated with the digital video to the IP marketplace.

Another innovative aspect of the subject matter described in this disclosure includes an apparatus for implementing an IP asset management platform using DLT. The apparatus may include a processor and memory having instructions stored therein which, when executed by the processor, cause the apparatus to obtain one or more files associated with an IP asset, process the one or more files to create a record on a distributed ledger that is associated with the IP asset, where the processing of the one or more may include, at least in part, generation of a hash from information associated with the one or more files and a timestamp, and create the record on the distributed ledger, the record including at least the hash and the timestamp.

In some implementations, the instructions may further cause the apparatus to generate a blockchain certificate for the IP asset after creation of the record on the distributed ledger, the blockchain certificate including at least the hash and the timestamp.

In some implementations, the instructions may further cause the apparatus to verify one or more utility tokens are included in an account of the IP asset management platform associated with the IP asset prior to processing the one or more files to create the record on the distributed ledger, and process the one or more files to create the record on the distributed ledger in response to verification that the account includes the one or more utility tokens.

In some implementations, the instructions may further cause the apparatus to provide one or more gas tokens associated with the DLT using the fee delegation feature to create the record on the distributed ledger in response to verification that the account includes the one or more utility tokens.

Another innovative aspect of the subject matter described in this disclosure includes a mobile device for implementing an IP asset management application using DLT. The mobile device may include a processor and memory having instructions stored therein which, when executed by the processor, cause the mobile device to capture a digital photograph using the IP asset management application that is associated with an IP asset management platform, automatically process one or more files associated with the captured digital photograph to create a record on a distributed ledger that is associated with the captured digital photograph, where the processing of the one or more files may include, at least in part, generation of a hash from information associated with the one or more files and a timestamp, and create the record on the distributed ledger, the record including the hash and the timestamp.

Another innovative aspect of the subject matter described in this disclosure can be implemented in a server, mobile device, or other computing device, which includes the above-mentioned apparatus that is configured to perform any of the above-mentioned methods.

Aspects of the subject matter described in this disclosure can be implemented in a device, a software program, a system, or other means to perform any of the above-mentioned methods.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 depicts a system diagram of an example IP management system using DLT.

FIG. 2 depicts a system diagram of another example IP management system using DLT.

FIG. 3 depicts a system diagram of another example IP management system using DLT that includes an IP marketplace.

FIG. 4 depicts a system diagram of another example IP management system using DLT that includes an IP asset management application.

FIG. 5 depicts one example process for creating a record on a DLT and obtaining proof of ownership and authorship for an IP asset using DLT.

FIG. 6 depicts one example smart contract setup that may be used with the IP asset management platform, the IP marketplace, and the DLT.

FIG. 7 depicts a flowchart showing example operations performed by an IP asset management platform that uses DLT.

FIG. 8 shows a block diagram of an example network.

FIG. 9 shows a block diagram of an example electronic device.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways.

The primary purpose of intellectual property laws is to promote innovation. Giving inventors the ability to protect their ideas allows them to freely create without fear that someone else will capitalize on their efforts. These protections are also meant to benefit society by encouraging inventors and artists to reveal their work.

When IP laws were originally formed, the idea was that inventors were not fully incentivized to release their creations, as there was no guarantee that they would benefit from this revelation, either socially or monetarily. However, IP laws have evolved and IP owners often obtain monetary and other benefits from their IP. For example, technology and other innovations have transformed the world economies and industries, and thus obtaining patents is now a savvy investment, and companies are increasingly spending money on researching and developing inventions that may be eligible for patents. As will be further described below, in some implementations, an IP management platform that uses distributed ledger technology (DLT) or blockchain technology may offer innovative features for IP owners to manage and monetize their IP.

Any person or entity who designs, writes, or creates any type of media related to their IP, which falls under one of the IP categories of patents, trademarks, copyrights, and trade secrets (whether that is nationally or internationally) is most likely aware of how easy the media can be stolen, copied, or otherwise misappropriated by other individuals or entities, both online or in regular commerce. When IP is misappropriated, IP owners can attempt to enforce their legal IP rights through legal procedures, in order to prove they are the rightful owner of the IP, stop the IP infringement, and in some instances receive monetary damages.

Although copyright laws are created to protect the copyright owner and their work, most copyright owners do not go through the process of formally registering their work in a government copyright office. Thus, it is often difficult for copyright owners (and other IP owners) to verify authorship or ownership of their work. Protecting and enforcing rights associated with copyrighted material is very difficult if they copyright owner cannot verify authorship and ownership. As will be further described below, in some implementations, an IP management platform that uses DLT or blockchain technology may offer innovative features for IP owners to establish and prove the authorship and ownership of their IP. In some implementations, an IP asset management application (or IP asset management app) that can be used by users on their mobile devices may integrate or access some or all of the features of the IP asset management platform, and provide additional features, such as providing the mobile device user the option of automatically and seamlessly obtaining proof of ownership and authorship for their IP asset using DLT as they capture media (such as a digital photograph or video).

Additional benefits and features of the IP asset management platform that uses distributed ledger technology (DLT) or blockchain technology will be described below. For example, the IP asset management platform may be used to link a network of IP professionals to the IP management platform that uses DLT and to the users/customers. As another example, the IP asset management platform may provide inheritance solutions for IP asset owners. As another example, the IP asset management platform may offer an IP asset marketplace to offer IP asset owners additional ways to monetize their IP assets. Additional benefits and features will be described below.

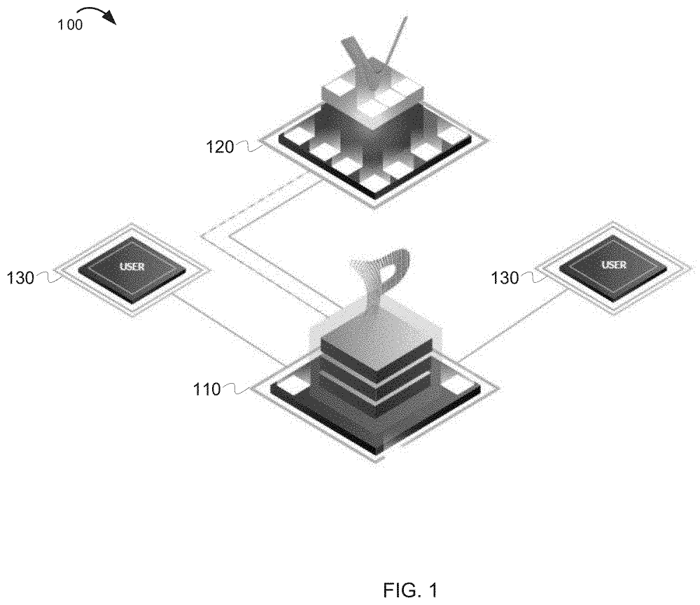

FIG. 1 depicts a system diagram of an example IP management system using DLT.

In some implementations, a IP asset management system 100 that is implemented using DLT may include an IP asset management platform 110 that uses a DLT 120 (which also may be referred to as a blockchain) to provide various IP management services and features to various users 130 (such as customers of the IP asset management platform 110). For example, the IP asset management platform 110 may use the immutable characteristic of DLT 120 to provide an immutable record of the authorship and ownership of an IP asset, such as a copyrighted work. In many jurisdictions, copyright protection is granted from the date of creation. Thus, the copyrighted work may be considered an IP asset that has an unregistered copyright, since it has not been formally registered in a government copyright office. The IP asset management platform 110 may provide an immutable record of the authorship and ownership of the copyright work even when it has not been formally registered in a government copyright office. The immutable record also provides a timestamp, which may serve as proof of the earliest date of authorship or ownership. The timestamp may be close to the date of creation (or the earliest date that can be verified), or may be the date of creation if submitted to the platform on the date the IP asset is created. In some implementations, the IP asset management platform 110 may return to the user 130 a DLT or blockchain certificate that may serve as proof that an immutable record of the IP asset was added to the DLT 120 and thus may be proof of authorship and ownership, as will be further described below.

In some implementations, a user 130 may use the IP asset management platform 110 to upload one or more files of their IP asset, one or more files that are in some way associated with or representative of the IP asset, or one or more files that show work-in-progress or draft documents that will lead to an IP asset. For example, the user 130 may upload a file of a digital photograph that has copyright protection (such as a digital photograph that has an unregistered copyright from the date of creation). As another example, the user 130 may upload one or more files of a trademark and a document showing that the trademark has been used in commerce. As another example, the user 130 may upload one or more files describing and/or depicting an idea or invention (or work-in-progress documents) that may be used for a patent application filing.

In some implementations, when the user 130 uploads one or more files in the IP asset management platform 110, a SHA-256 algorithm may be used to compute a hash of the one or more files. A SHA-256 hash of the user's email, the SHA-256 hash of the one or more files, and a timestamp may then be stored on the DLT 120 (or blockchain). A hash may not be considered an encryption, as it cannot be decrypted back to the original text (that is, a hash is a ‘one-way’ cryptographic function, and is a fixed size for any size of source text). This makes it suitable to comparing ‘hashed’ versions of files, as opposed to decrypting the output to obtain the original version. SHA-256 is one of the successor hash functions to SHA-1 (collectively referred to as SHA-2), and is one of the strongest hash functions available. In some implementations, the immutable record on the DLT 120 of the IP asset (or other associated files of an IP asset or legal document) may include the SHA-256 hash of the user's email, the SHA-256 hash of the one or more files, and a timestamp. It is noted, however, that in other implementations, different or additional information may be stored in the immutable record on the DLT 120. For example, a SHA-256 hash of the user's name or corporation name may also be added. As another example, additional metadata may be added to the immutable record.

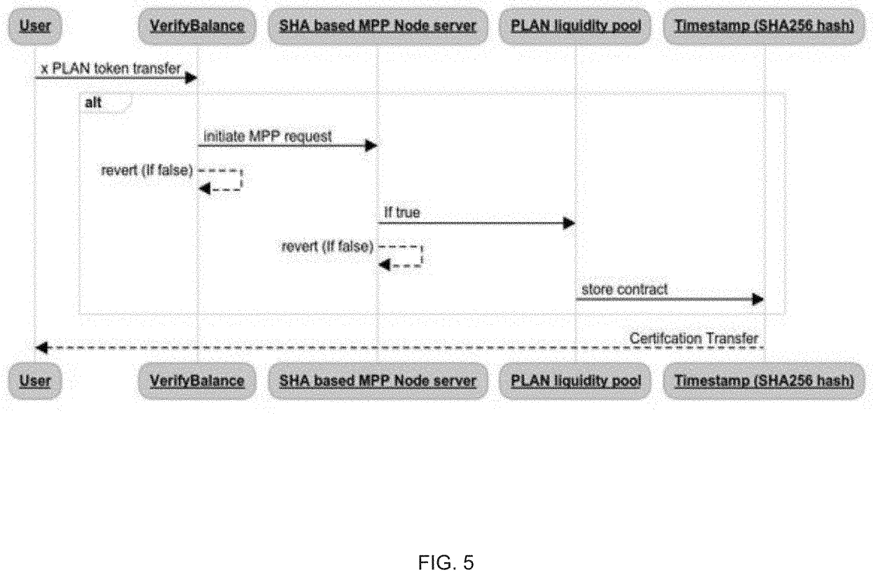

Digital assets or utility tokens may be used in DLT or blockchain networks. In some implementations, when the user uploads the one or more files associated with their IP asset (or other type of file), the user may also submit one or more digital tokens to pay for and power the transaction. FIG. 5 shows one example of the process described herein. The one or more digital tokens may pay for the fee charged by the company that runs the IP asset management platform for the service, and also may provide utility by powering the DLT-based transaction and creating the immutable record on the DLT 120. For example, DLTs and blockchain networks, such as the DLT 120, have a transaction cost or gas that is paid to perform a DLT-based transaction and create the immutable record. The one or more digital tokens that are submitted by the user may provide utility by paying the gas costs and creating the immutable record on the DLT 120. In some implementations, the user may have an account on the IP asset management platform 110, and the user's utility tokens may be kept in the user's account. For example, the user may transfer the user's utility tokens to the account to be used for the IP asset management system 100. In some implementations, the IP asset management platform 110 may offer users the option to pay with cash (such as ACH), debit, credit, or other payment means, and the IP asset management platform 110 (or via some integration with a partner network or platform) can automatically convert the payment to utility tokens for use in the IP asset management platform 110 and the DLT 120. In some implementations, the IP asset management platform 110 may offer users the option to pay with different digital assets or utility tokens, and the IP asset management platform 110 (or via some integration with a partner network or platform) can automatically convert (such as via atomic swaps or other means) the digital asset to the utility tokens for use in the IP asset management platform 110 and the DLT 120.

In some implementations, after submission of the utility tokens is verified, or the IP asset management platform 110 verifies the user has sufficient balance of utility tokens in the user's account, the IP asset management platform 110 can use the one or more utility tokens and the DLT 120 to create the immutable record for the user, as described above. In some implementations, after submission of the utility tokens is verified, the IP asset management platform 110 may utilize a portion of the one or more utility tokens (or a portion of one of the utility tokens) to pay for the transaction cost or the transaction gas for performing a transaction on the DLT 120 and creating the immutable record. In some implementations, after submission of the utility tokens is verified, the IP asset management platform 110 may use a fee delegation mechanism to pay for the transaction cost or transaction gas for performing the transaction on the DLT 120. For example, the DLT 120 may use a different token, which may be referred to as a gas token, for payment of the transaction costs of the DLT 120. Using the fee delegation mechanism, the IP asset management platform 110 may pay for the transaction costs on the DLT 120 for the user using one or more gas tokens associated with the DLT 120 after verification of the user's utility tokens. The IP asset management platform 110 may keep gas tokens on an account for fee delegation purposes. This makes the transaction easier for the user because the user does not have to own two different types of tokens. In some implementations, instead of a fee delegation mechanism, the IP asset management platform 110 may implement an atomic swap mechanism that automatically and seamlessly swaps or converts a portion of the one or more utility tokens (or a portion of one of the utility tokens) submitted by the user into the one or more gas tokens that will be used for the transaction costs on the DLT 120. The gas tokens may then be used to transact with the DLT 120 and create the immutable record. In some implementations, the IP asset management platform 110 may offer users the option to convert cash (such as ACH), debit, credit, or other payment means, to the one or more gas tokens that will be used for the transaction costs on the DLT 120.

After creating the immutable record, the IP asset management platform 110 generates the DLT or blockchain certificate, and provides the DLT certificate to the user. The user may store the DLT certificate in digital form and may print a hard copy. The DLT certificate may include information regarding the DLT record that was created in the DLT 120. For example, the DLT certificate may include one or more of the timestamp, the owner's name (such as an individual's name or company name), a description of the IP asset (or the files associated with the IP asset or other legal document), a thumbnail or other picture of the IP asset (if applicable, such as a thumbnail of a photograph or the front page of an issued patent), the block number associated with the DLT 120, and the generated hash. It is noted, however, that in other implementations different or additional information may be included in the DLT certificate, such as additional metadata associated with the IP asset or IP owner.

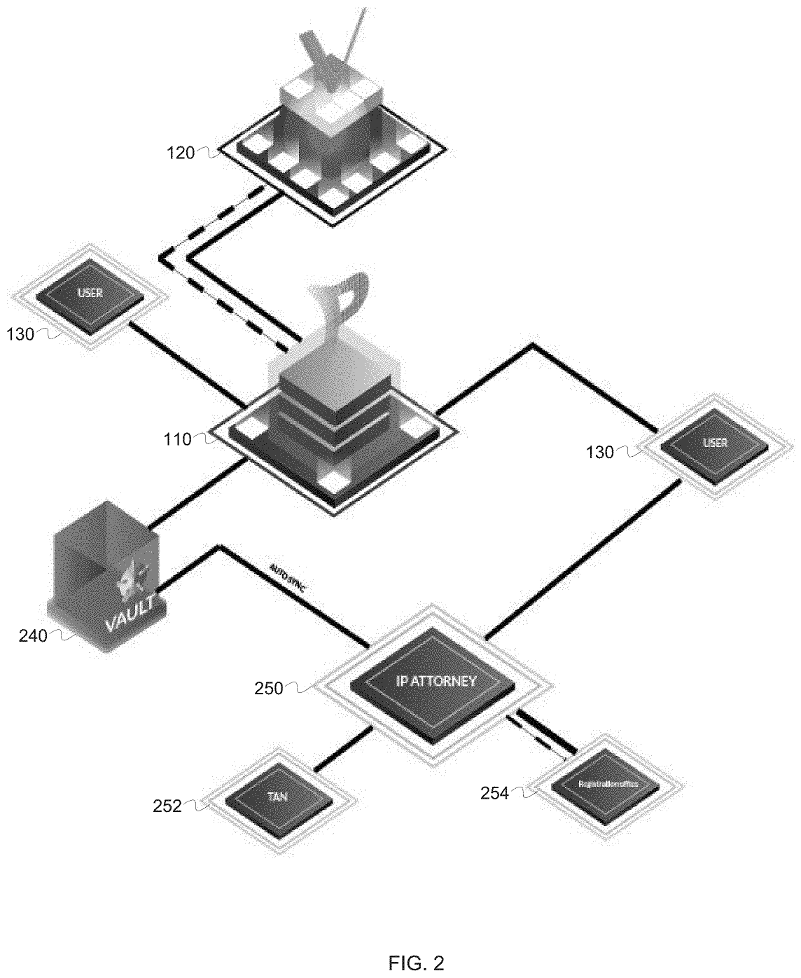

FIG. 2 depicts a system diagram of another example IP management system using DLT. Similar to FIG. 1, the IP asset management system 100 that is implemented using DLT may include the IP asset management platform 110 and the DLT 120. In some implementations, the IP asset management system 100 also may include an IP asset vault 240. In some implementations, the IP asset management system 100 may be linked to the systems of a law firm network 250 that is comprised of one or more IP attorneys or IP law firms that may be distributed worldwide. The law firm systems 250 (and in some cases the IP asset management platform 110 and/or the IP asset vault 240) may be linked to a trusted alliance network 252 of other professionals, such as other attorneys or law firms in different practice areas or professionals in the financial sector. The law firm systems 250 (and in some cases the IP asset management platform 110 and/or the IP asset vault 240) also may be linked to government registration offices 254 of different countries or jurisdictions around the world.

In some implementations, the IP asset vault 240 may be used by users 130 (such as customers of the IP asset management platform 110) to store their blockchain certificates, the files associated with their IP assets, and any working files associated with any IP-related projects (or other legal projects or documents) the user is working on. All the files and other content that is stored in the IP asset vault 240 will be encrypted using one or more of the latest encryption mechanisms. In some implementations, when a user 130 uses the services of an IP attorney or IP law firm from the law firm network 250, the IP attorney or law firm may be granted access (either full or restricted) to the user's working files associated with any IP-related projects. For example, the user 130 may store working files of an invention or idea, or other invention disclosure documents, in the IP asset vault 240, and the law firm may be granted access to these files to prepare a patent application for the user 130. The law firm may then file the patent application with one or more government registration offices 254 (such as the USPTO). Similarly, law firms may be granted access to a user's files to prepare a trademark application, or files to formally register a copyright for a user. In some implementations, the IP asset management platform 110 may offer a feature whereby a hash of the user's working files that are in progress is created and stored on the DLT 120 (on the blockchain) periodically to have an immutable and timestamped proof of the user's working files of an IP-related project.

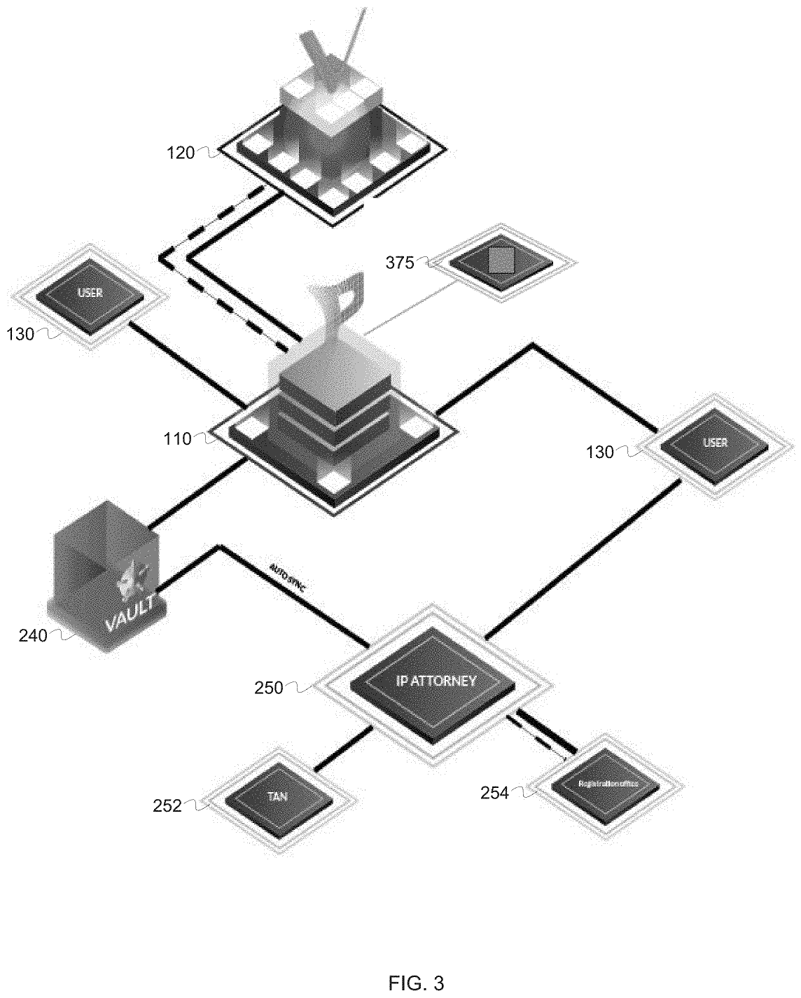

FIG. 3 depicts a system diagram of another example IP management system using DLT. Similar to FIG. 2, the IP asset management system 100 that is implemented using DLT may include the IP asset management platform 110, the DLT 120, and the IP asset vault 240. In some implementations, the IP asset management system 100 also may be linked to the systems of a law firm network 250 that is comprised of one or more IP attorneys or IP law firms that may be distributed worldwide. The IP asset management system 100 also may be directly or indirectly linked to a trusted alliance network 252 of other professionals, such as other attorneys or law firms in different practice areas or professionals in the financial sector. The IP asset management system 100 also may be directly or indirectly linked to government registration offices 254 of different countries or jurisdictions around the world. In some implementations, the IP asset management system 100 also may include an IP marketplace 375 that may be used to monetize user's IP assets.

In some implementations, the IP marketplace 375 may be used to sell, license, trade, auction, or otherwise monetize user's IP assets. After a user 130 uses the IP asset management platform 110 to create an immutable record on the DLT 120 and obtains a blockchain certificate, the user 130 may add the IP asset to the IP marketplace 375 in order to monetize the IP asset. The user 130 may upload one or more files associated with the IP asset into the IP marketplace 375 to market the IP asset for sale, license, trade, auction, etc. For example, if the IP asset is a copyrighted photograph, the user 130 may upload a file of the photograph to the IP marketplace 375. If the IP asset is an issued patent, the user 130 may upload an image of the front page of the issued patent (or the full issued patent) that includes the patent number, title, abstract, one or more figures, etc. In some implementations, the user 130 may use the IP asset management platform 110 or the IP marketplace 375 to generate a non-fungible token (NFT) that represents the IP asset and which may include metadata associated with the IP asset. A digital representation of the NFT that represents the IP asset may then be uploaded into the IP marketplace 375 (either based on a user command, or automatically after creation of the NFT). For example, an NFT may be generated of a copyrighted photograph, and the NFT that represents the photograph may be uploaded to the IP marketplace 375 to monetize the photograph.

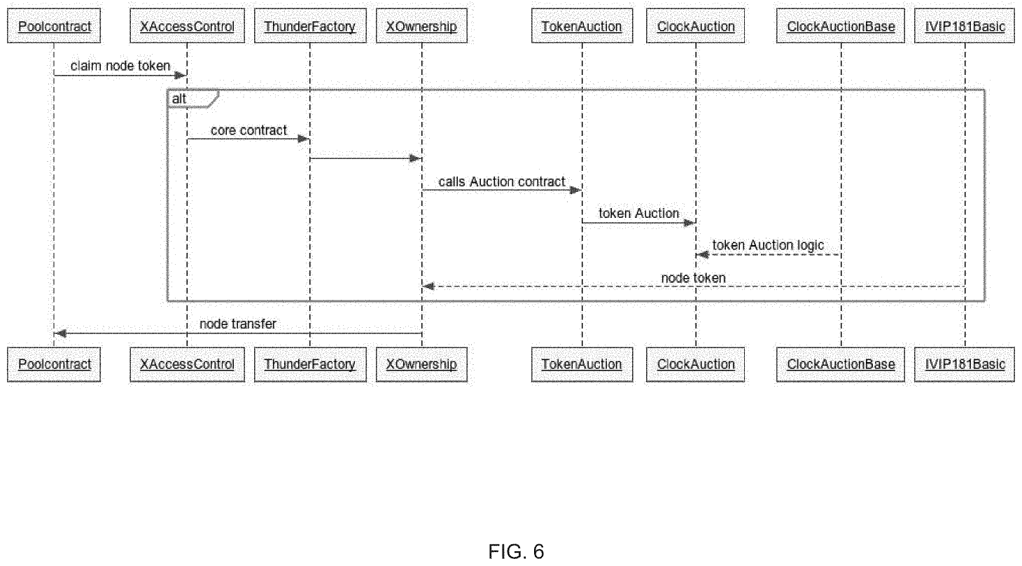

In some implementations, in order to allow the IP asset to be traded, sold, licensed, etc., the IP asset is given a digital footprint that can be sent and received, and in which ownership can be changed fast (and efficiently), securely, and transparently. Using DLT (such as DLT 120), this may be achieved using a smart contract, such as the example shown in FIG. 6. FIG. 6 is one example smart contract setup that may be used with the IP asset management platform 110, the IP marketplace 375, and DLT 120. In some implementations, the smart contract may use NFTs, such as the VIP-181 standard NFTs (for Vechain blockchain) or ERC-721 standard NFTs (for Ethereum blockchain), among others. In some implementations, the smart contract setup may be decentralized and may allow the IP asset to be sold, traded, etc. on the IP marketplace 375. In some implementations, the NFTs may be unique and ownership may be claimed by the wallet address holding that specific, unique NFT.

In some implementations, the IP marketplace 375 may be organized in a variety of manners. For example, the IP marketplace 375 may be organized based on the type of IP asset, such as based on whether the IP asset is a patent, copyright, or trademark (i.e., organized in different IP type categories). Within each IP category, the IP assets may be organized into subcategories based on the type of IP assets. For example, under copyrights, the subcategories may be photographs, video, art (such as digital art), poems, stories, music, and other types of copyrighted materials. Under patents, the subcategories may be technical areas, such as web-based networks, local area networks, encryption, processor architecture, medical instrumentation, industrial tools, etc. For example, the technical areas may correspond to the technical areas that have been set by the USPTO.

In some implementations, the IP marketplace 375 also may be organized into different user profiles, which may be profiles of individuals, companies or other entities that have IP assets listed in the IP marketplace 375. In some implementations, the users 130 may create a profile in the IP marketplace 375 that provides information about the user and displays all of the IP assets the user is looking to monetize. For example, a photographer can provide a CV and other information about his or her career and experience and display all of the photographer's IP assets that are in the IP marketplace 375, such as a portfolio of photographs, videos, and other works that have copyright protection and have a blockchain certificate via the IP asset management platform 110.

It is noted that, in some implementations, the IP marketplace 375 may be organized in various other ways and using other categories and subcategories, and the IP marketplace 375 may be searchable by keywords, images, and by other means. For example, as will be further described below, another category may be IP asset pools or IP asset auctions.

In some implementations, a user 130 (which may be one or more companies) can pool two or more IP assets into an IP pool and try to monetize the IP pool or group, in addition to individual IP assets. In some transactions, IP asset owners may be able to more successfully monetize their IP assets as a pool rather than individually. In some implementations, the user 130 may use the IP asset management platform 110 and the IP marketplace 375 to create an IP asset pool from two or more of their IP assets. The user 130 may add description (and perhaps terms and conditions specific to that IP asset pool) and keywords to the IP asset pool to market the IP asset pool to potential customers and to be searchable using the search feature of the IP marketplace 375. In some implementations, multiple users (such as multiple individuals, multiple companies or other entities) can pool their IP assets together to make an IP asset pool for the IP marketplace 375.

In some implementations, whether a user lists a single IP asset in the IP marketplace 375 or an IP asset pool with multiple assets, the IP asset management platform 110 and the IP marketplace 375 may create a smart contract to automatically and seamlessly control the sale, license, trade, auction, etc. of the IP asset or IP asset pool. For example, for a single IP asset, the IP marketplace 375 may receive payment from a customer for one of the listed IP asset of a user 130. For example, the payment may be received by means of one or more utility tokens associated with the IP asset management platform 110. As described above, various other forms of payment may be accepted (such as currencies, credit cards, other utility tokens or cryptocurrencies), and the IP asset management platform 110 may convert (or swap) the other payment types into the utility tokens for use in the IP asset management system 100. Also, in some implementations, customer information may be requested and obtained to verify the customer, or at least to verify the payment (such as if credit cards are used). In some implementations, the received utility tokens (that correspond to the amount the user 130 was requesting for sale) may trigger the IP asset transfer of ownership transaction on the IP marketplace 375, the IP asset management platform 110, and the DLT 120. For example, for a patent sale, the receipt of the utility tokens may trigger the automatic generation of the assignment forms and other documents for the transfer of ownership of the IP asset. Similarly, for a license transaction, the license agreement and other documents to perform the license transaction may be automatically generated. In some implementations, the documents may be electronically signed and printed and submitted to the necessary authorities using the network of IP law firms, or when the IP asset management platform 110 is linked to the government offices such as a government registration or IP office (e.g., the USPTO), the signed forms may be automatically submitted. As similar process may be implemented for a sale or license of an IP asset pool from a single user. In some implementations, for an IP asset transaction or IP asset pool transaction involving multiple users 130 (such as multiple companies or individuals), the IP marketplace 375 and the IP asset management platform 110 may also include a smart contract feature that automatically distributes a percentage of the sale funds or licensing funds to each user of the group of users that listed the IP asset pool. In some implementations, when creating the IP asset pool, the IP marketplace 375 and the IP asset management platform 110 may automatically create a smart contract with the terms agreed upon by the members of the IP asset pool, including the percentage of the funds that will go to each of the members of the IP asset pool. In some implementations, the smart contract for the IP asset pool may be generated after the IP assets are linked or uploaded to the IP marketplace 375 and after utility tokens are received from the members of the IP asset pool.

In some implementations, smart contracts and access to partner company's software solution (that use DLT/blockchain), such as access via an API, may allow an IP asset to be presented by an NFT, and may allow a pool contributor source wallet addresses to be the IP pool owners. In some implementations, the smart contract may include pool thresholds or conditions (such as that information of each participant has been verified, the IP assets have been linked in the pool, among others). In some implementations, from the moment the pool thresholds or conditions are met, separate tokens (such as NFTs) may be deployed for shared ownership recognition of the IP asset pool.

In some implementations, as described above, the IP marketplace 375 and the IP asset management platform 110 may allow users to list one or more IP assets or an IP asset pool for sale via an auction format. Similar to the examples described above, when the user 130 creates the auction (including providing any utility tokens for the auction feature and transaction), the IP marketplace 375 and the IP asset management platform 110 may generate a smart contract that will automatically manage the IP asset auction, including the transfer of ownership to the winner of the auction.

In some implementations, the IP marketplace 375 and the IP asset management platform 110 may provide another feature to users and customers to buy or sell fractional shares of IP assets. For example, a user or multiple users may list an IP asset or a pool of IP assets in the IP marketplace 375 for sale, and the sale may provide customers the option to buy fractional shares of the IP asset or the IP asset pool. This may provide the average customers a chance to own a fraction of an IP asset or IP asset pool that is of high value. Also, this may open the market of customers/buyers to the users (sellers) because now a larger number of customers/buyers can participate in the sale. Similar to transaction involving an IP asset pool, when the IP asset sale with fractional shares is created, a smart contract may be generated that will manage the sale and also manage the transfer of fractional ownership and other legal documents necessary for such as sale.

In some implementations the IP asset management platform 110 and the IP marketplace 375 may offer inheritance solutions to users for their IP assets that have blockchain certificate through the IP asset management platform 110 and for IP assets that are listed in the IP marketplace 375. Also, the IP asset management platform 110 and the IP marketplace 375 may offer inheritance solutions to users for the NFTs of the IP assets (that is, IT assets that have been tokenized). In some implementations, the IP asset management platform 110 may generate a smart contract that generates legal inheritance documents for the IP assets. The smart contract may also generate an immutable record of the transaction on the DLT 120. The smart contract may also automatically send the inheritance documents to inheritance, financial, or legal professionals, such as professionals that are part of the TAN 252 or attorney/law firm network 250. In some implementations, the IP asset management platform 110 may integrate a software solution (that uses DLT/blockchain) from a partner company to provide the inheritance solution to all the users 130 of the IP asset management platform 110. For example, the IP asset management platform 110 may integrate or access at least some of the inheritance solutions from SafeHaven/SafeTech.

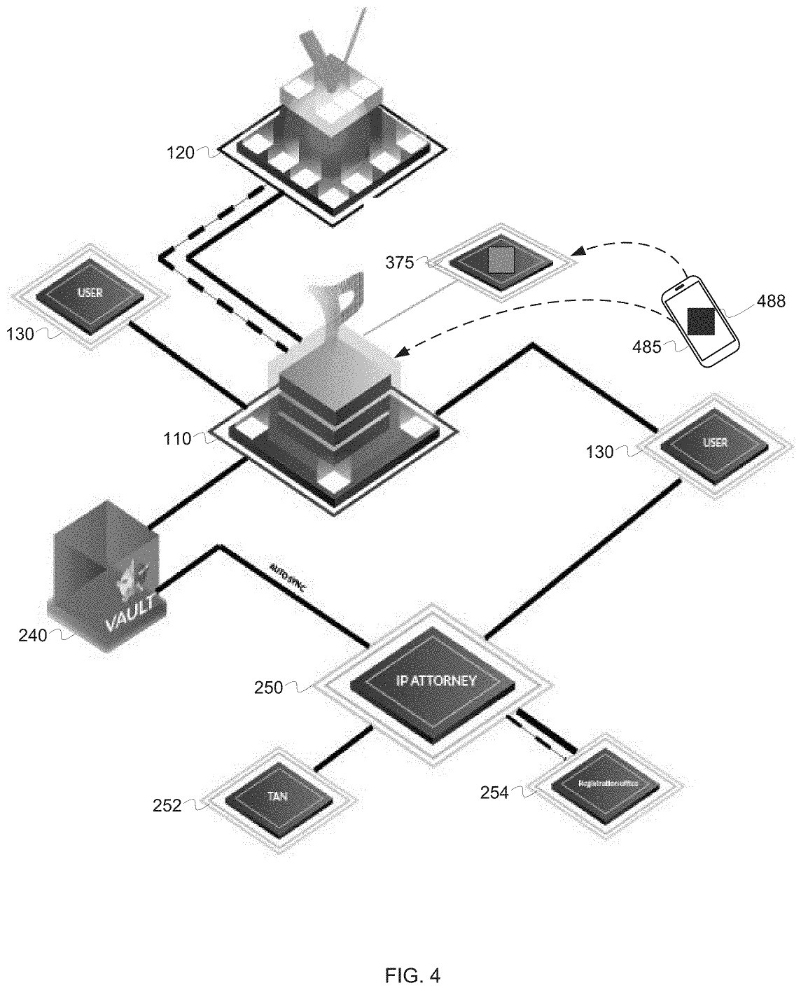

FIG. 4 depicts a system diagram of another example IP management system using DLT. Similar to FIG. 3, the IP asset management system 100 that is implemented using DLT may include the IP asset management platform 110, the DLT 120, the IP asset vault 240. In some implementations, the IP asset management system 100 also may be linked to the systems of a law firm network 250, linked to a trusted alliance network 252 of other professionals, and/or linked to government registration offices 254. In some implementations, the IP asset management system 100 also may include an IP marketplace 375 that may be used to monetize user's IP assets, such as to sell, license, trade, auction, or otherwise monetize user's IP assets. In some implementations, the users 130 also may access some or all of the features of the IP asset management system 100 (and have additional features) via an IP asset management platform mobile application 488 (which may be referred to as IP asset management app 488). For example, a user 130 may access and use the IP asset management app 488 on a mobile device 485, such as an application available in any mobile operating system (such as android, iOS, or others).

In some implementations, as shown in FIG. 4, the IP asset management app 488 may integrate at least some aspects and features of the IP asset management platform 110 and the IP marketplace 375 into the app interface and features, or may access the IP asset management platform 110 and the IP marketplace 375 via the app interface. In some implementations, the IP asset management app 488 may allow the user 130 to automatically and seamlessly create an immutable record on the DLT 120 and obtain proof of ownership and authorship (and also obtain a blockchain certificate) for a photograph or video (or other digital media) concurrently or immediately following the time the user 130 takes the photograph or video. For example, the IP asset management app 488 may include the feature of instantly obtaining the proof of ownership and authorship via DLT 120 that can be enabled or disabled. In some implementations, if the instant feature is disabled, then the user 130 can manually select one or more of the IP assets (such as photographs or videos) on the interface of the IP asset management app 488 at a later time and perform the similar operations as described in FIG. 1 for obtaining the proof of ownership and authorship using the DLT 120 for the one or more IP assets (such as photographs or videos or moving/live photograph, or other digital media or IP assets).

In some implementations, similar as described in FIG. 1, the IP asset management app 488 may accept the utility token of the IP asset management platform 110, and perform similar operations as described in FIG. 1 to create the immutable record on the DLT 120, obtain the proof of ownership and authorship, and obtain the blockchain certificate. In some implementations, the IP asset management app 488 also may allow different forms of payment, such as currencies or other digital assets or utility tokens (which may be converted or swapped to the utility token), similarly as was described above for the IP asset management platform 110. In some implementations, after creating the immutable record on the DLT 120, obtaining the proof of ownership and authorship, and obtaining the blockchain certificate, the IP asset management app 488 may also allow the user 130 to instantly add or upload the IP asset to the IP marketplace 375 (for example, by performing similar operations as described above in FIG. 3). In some implementations, when adding or uploading the IP asset (such as a photograph or video) to the IP marketplace 375, the IP asset management app 488 may allow the user 130 to convert the IP asset (or to represent the IP asset) as a NFT and then deploy the NFT of the IP asset to the IP marketplace 375. In some implementations, the IP asset management app 488 may not allow filters, and in some implementations the IP asset management app 488 may allow filters. In some implementations, the IP asset management app 488 may add metadata such as one or more of dimensions, quality, asset owner's details, time, etc., similar as described above for the IP asset management platform 110. In some implementations, in the instant feature, concurrently or immediate after (or shortly after) the user takes the photo (or video), the IP asset management app 488 may automatically add a signature at one of the corners (such as the bottom right-hand corner) or one of the edges (such as the bottom edge) of the photograph (or one or more of the frames of a video or moving/live photogram). For example, the signature may be the hash (or a portion of the hash) that was generated when creating the immutable record on the DLT 120. As another example, the signature may include some owner signature or QR code, or other identifier. For example, the QR code or other identifier or code or embedded hyperlink may allow the user or interested customers to access the IP asset on the IP marketplace 375, or access other IP assets (such as the user's portfolio of photographs, videos, etc.) in the IP marketplace 375. In some implementations, the IP asset management app 488 may include an option on the user interface that enables or disables the feature of adding a signature to the IP asset. Similar to the examples described above in FIG. 1 for the IP asset management platform 110, the blockchain certificate may be automatically emailed to the user 130 after the immutable record is created in the DLT 120 (and the blockchain certificate may include a thumbnail of the photo, timestamp, owner's information, etc. as described above in FIG. 1).

In some implementations, the IP asset management app 488 may access the camera software (and in some cases hardware, directly or indirectly) of the mobile phone 485 to allow the user 130 to take the picture or video. For example, the IP asset management app 488 may access the camera software, including the camera features (such as zoom in or zoom out, flash, etc.), the camera field of view, and certain aspects of the camera user interface. In some implementations, the IP asset management app 488 may access the camera software, features, etc., and may include its own user interface, at least in part. In some implementations, the IP asset management app 488 may have a hybrid user interface, which may have some aspects of the camera user interface of the mobile phone 485 and may have some custom user interface aspects that allow the user 130 to use some of the DLT-specific features of the IP asset management app 488. For example, the user interface may include one or more buttons or other user interface components that can enable or disable the instant feature or the signature feature, as described above. As another example, the user interface may include a button or other user interface component that allows the user to instantly upload the IP asset to the IP marketplace 375. As another example, the user interface may include a button or other user interface component that enables or disables the feature of emailing the blockchain certificate to the user. It is noted that the user interface may include other buttons, menus, and other user interface components in the user interface to implement the features described herein in this disclosure.

In some implementations, a company website, platform, mobile application, or other product/system from another company or entity, such as a partner company or licensee, may integrate at least some aspects and features of the IP asset management platform 110 and the IP marketplace 375, or may include an interface to access the IP asset management platform 110 and the IP marketplace 375. For example, a partner company or entity may include a system, platform or other product that integrates some aspect of the IP asset management platform 110 to accept the utility token (or accept another form of payment, such as another utility token or currency that can be converted to the utility token) and allow the upload of an IP asset (such as a photogram) in order to generate an immutable record in the DLT 120 for proof of authorship and ownership, using similar operations as described in FIG. 1. The system, platform or other product of the partner company or entity may also integrate or access the IP marketplace 375. After performing some of the operations described in FIG. 1 for obtaining the proof of ownership and authorship, the system, platform or other product of the partner company may also allow the IP asset owner to upload the IP asset to the marketplace 375 (and perform other operations and have other features that were described above in FIG. 3), which in some cases may be a NFT of the IP asset.

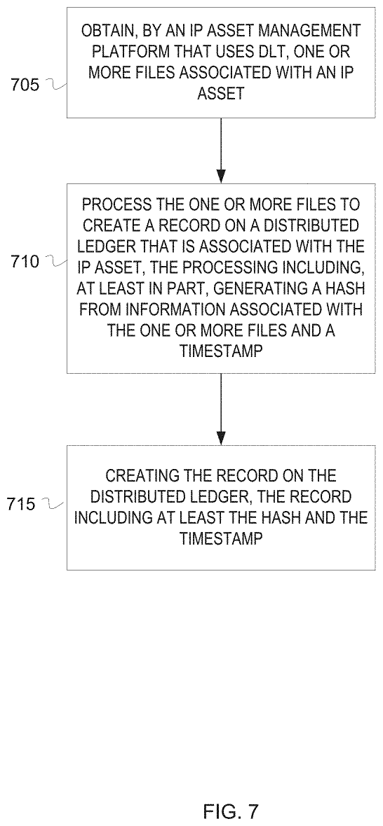

FIG. 7 depicts a flowchart 700 showing example operations performed by an IP asset management platform that uses DLT.

At block 710, the IP asset management platform may obtain one or more files associated with an IP asset.

At block 720, the IP asset management platform may process the one or more files to create a record on a distributed ledger that is associated with the IP asset. The processing may include, at least in part, the generation of a hash from information associated with the one or more files and the generation of a timestamp.

At block 730, the IP asset management platform may create the record on the distributed ledger. The record including at least the hash and the timestamp.

In some implementations, the IP asset management platform may generate a blockchain certificate for the IP asset after creating the record on the distributed ledger, as described above in FIG. 1.

In some implementations, the IP asset management platform may verify that one or more utility tokens are received prior to processing the one or more files to create the record on the distributed ledger, as described above in FIG. 1.

In some implementations, the IP asset management platform may upload the IP asset to an IP marketplace for sale, license, trade, etc., as described above in FIG. 3.

In some implementations, some of these features, and additional features, may also be implemented in an IP asset management application, as described above in FIG. 4.

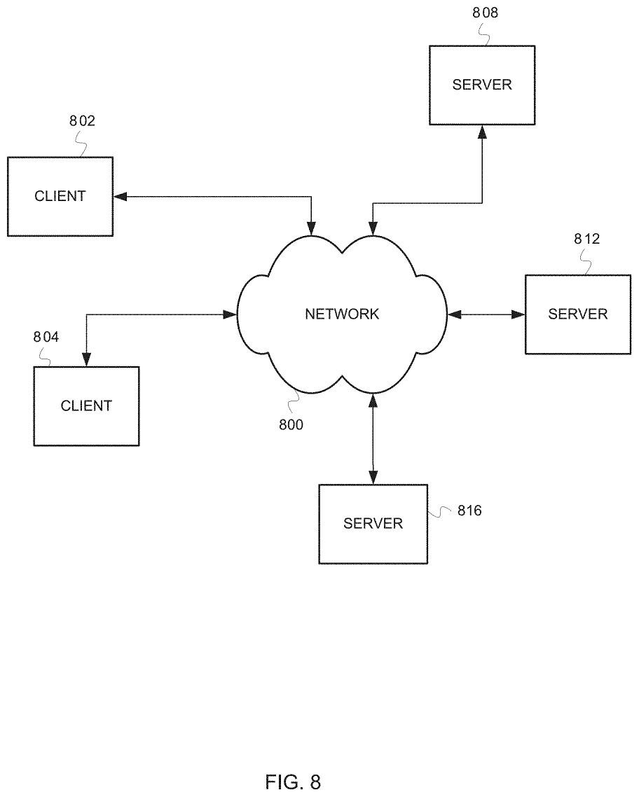

Some examples in this disclosure describe an IP asset management system and platform that may be implemented using DLT or blockchain technology. It is noted that, in some implementations, the IP asset management system and platform may be implemented using various types of DLTs or blockchains, or various types of wide area networks, or various types of distributed networks, or other similar type of networks. For example, FIG. 8 may depict an example network 800 of various servers 808, 812, 816 and clients 802, 804, which also may be referred to as computers or nodes (some which may be mobile devices), and which may implement the IP asset management system and platform. For example, some or all of the servers, clients, or nodes may implement at least one of the IP asset management platform 110, the IP asset management app 488, and the IP marketplace 375, or other members of the IP asset management system 100. The IP asset management system and platform may be implemented using a public blockchain, a private blockchain, a hybrid blockchain that certain aspects are public and other aspects are private, a centralized blockchain, a decentralized blockchain, a hybrid blockchain that has certain aspects that are centralized and other aspects that are decentralized, among others. In some implementations, the IP asset management system and platform may be implemented using a DLT or blockchain that implements a proof of authority consensus algorithm, a proof of stake algorithm, a delegated proof of stake algorithm, a proof of work algorithm, one of the variations of byzantine fault tolerance algorithms, other variations of proof of authority, proof of stake, or proof of work algorithms, a tangle-type algorithm and architecture, among others.

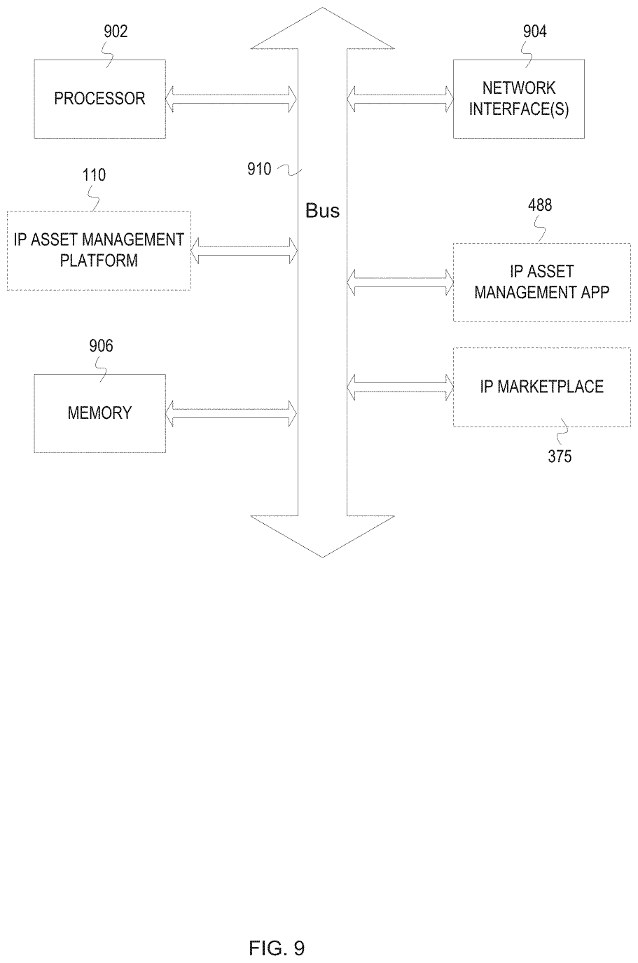

FIG. 9 shows a block diagram of an example electronic device 900. In some implementations, the electronic device 900 may be one of a server, client, desktop computer, mobile device, laptop, table computer, wearable device, and other types of computing devices. The electronic device 900 can include a processor 902 (possibly including multiple processors, multiple cores, multiple nodes, or implementing multi-threading, etc.). The electronic device 900 also can include a memory 906. The memory 906 may be system memory or any one or more of the possible realizations of computer-readable media described herein. The electronic device 900 also can include a bus 910 (such as PCI, ISA, PCI-Express, HyperTransport®, InfiniBand®, NuBus,® AHB, AXI, etc.), and a network interface(s) 904 that can include at least one of a wireless network interface (such as a WLAN interface, a WAN interface, a Bluetooth® interface, a ZigBee® interface, a Wireless USB interface, etc.) and a wired network interface (such as an Ethernet interface, a powerline communication interface, etc.). In some implementations, the electronic device 900 may support multiple network interfaces—each of which is configured to couple the electronic device 900 to a different communication network.

In some implementations, the electronic device 900 may implement or execute (for example, using the processor 902 and memory 906, and either the electronic device 900 alone, or in a distributed manner with other electronic devices/computing devices) one or more of the IP asset management platform 110, IP marketplace 375, and the IP asset management app 488 (as indicated by the dashed lines). In some implementations, the electronic device 900 may access the DLT 120 and/or may be one of the nodes that are part of the DLT 120. As described above, the electronic device 900 may be one of various computing devices that form the IP asset management system 100, and/or may be one of various computing devices or nodes that form the DLT 120.

The memory 906 can include computer instructions executable by the processor 902 to implement the functionality of the implementations described in FIGS. 1-8. Any of these functionalities may be partially (or entirely) implemented in hardware or on the processor 902. For example, the functionality may be implemented with an application specific integrated circuit, in logic implemented in the processor 902, in a co-processor on a peripheral device or card, etc. Further, realizations may include fewer or additional components not illustrated in FIG. 9 (such as video cards, audio cards, additional network interfaces, peripheral devices, etc.). The processor 902, the memory 906, and the network interface(s) 904 are coupled to the bus 910. Although illustrated as being coupled to the bus 910, the memory 906 may be coupled to the processor 902.

FIGS. 1-9 and the operations described herein are examples meant to aid in understanding example implementations and should not be used to limit the potential implementations or limit the scope of the claims. Some implementations may perform additional operations, fewer operations, operations in parallel or in a different order, and some operations differently.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray™ disc where disks usually reproduce data magnetically, while discs reproduce data optically with lasers. Combinations also can be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method performed by an intellectual property (IP) asset management platform using distributed ledger technology (DLT), comprising:
obtaining one or more files associated with an IP asset;
processing the one or more files to create a record on a distributed ledger that is associated with the IP asset, the processing including, at least in part, generating a hash from information associated with the one or more files and a timestamp; and
creating the record on the distributed ledger, the record including at least the hash and the timestamp.

2. The method of claim 1, further comprising:
generating a blockchain certificate for the IP asset after creating the record on the distributed ledger, the blockchain certificate including at least the hash and the timestamp.

3. The method of claim 2, wherein the blockchain certificate further includes one or more of ownership information, a description of the IP asset, a thumbnail of the IP asset, and a block number associated with the record on the distributed ledger.

4. The method of claim 1, further comprising:
verifying one or more utility tokens are received prior to processing the one or more files to create the record on the distributed ledger.

5. The method of claim 1, further comprising:
generating a non-fungible token (NFT) associated with the IP asset.

6. The method of claim 5, further comprising:
uploading the IP asset to an IP marketplace after generating the NFT.

7. The method of claim 6, wherein uploading the IP asset to the IP marketplace includes at least uploading the NFT associated with the IP asset to the IP marketplace.

8. The method of claim 6, further comprising:
listing the IP asset in the IP marketplace to be sold, traded, licensed, or auctioned.

9. The method of claim 6, further comprising:
pooling the IP asset with one or more additional IP assets to create an IP asset pool; and
listing the IP asset pool in the IP marketplace.

10-11. (canceled)

12. The method of claim 1, further comprising:
providing an inheritance feature to the IP asset in the IP asset management platform.

13. The method of claim 1, further comprising:
receiving one or more utility tokens prior to processing the one or more files to create the record on the distributed ledger;
processing the one or more files to create the record on the distributed ledger in response to receiving the one or more utility tokens; and
implementing a fee delegation feature using, at least in part, the one or more utility tokens.

14. The method of claim 1, further comprising:
verifying one or more utility tokens are included in an account of the IP asset management platform associated with the IP asset prior to processing the one or more files to create the record on the distributed ledger; and
processing the one or more files to create the record on the distributed ledger in response to verifying the account includes the one or more utility tokens.

15. The method of claim 14, further comprising:
implementing a fee delegation feature in response to verifying the account includes the one or more utility tokens.

16. The method of claim 15, further comprising:
providing one or more gas tokens associated with the DLT using the fee delegation feature to create the record on the distributed ledger in response to verifying the account includes the one or more utility tokens.

17. The method of claim 15, further comprising:
converting at least a portion of a utility token of the one or more utility tokens into one or more gas tokens associated with the DLT using the fee delegation feature to create the record on the distributed ledger in response to verifying the account includes the one or more utility tokens.

18. A method performed by an intellectual property (IP) asset management application being executed on a mobile device and using distributed ledger technology (DLT), comprising:
capturing a digital photograph using the IP asset management application that is associated with an IP asset management platform;
automatically processing one or more files associated with the captured digital photograph to create a record on a distributed ledger that is associated with the captured digital photograph, the processing including, at least in part, generating a hash from information associated with the one or more files and a timestamp; and
creating the record on the distributed ledger, the record including the hash and the timestamp.

19. The method of claim 18, further comprising:
after capturing the digital photograph, automatically generating a non-fungible token (NFT) associated with the digital photograph.

20. The method of claim 19, further comprising:
automatically uploading the digital photograph to an IP marketplace.

21-25. (canceled)

26. An apparatus for implementing an intellectual property (IP) asset management platform using distributed ledger technology (DLT), comprising:
a processor; and
memory having instructions stored therein which, when executed by the processor, cause the apparatus to:
obtain one or more files associated with an IP asset;
process the one or more files to create a record on a distributed ledger that is associated with the IP asset, wherein the processing of the one or more includes, at least in part, generation of a hash from information associated with the one or more files and a timestamp; and
create the record on the distributed ledger, the record including at least the hash and the timestamp.

27. The apparatus of claim 26, wherein the instructions further cause the apparatus to:
generate a blockchain certificate for the IP asset after creation of the record on the distributed ledger, the blockchain certificate including at least the hash and the timestamp.

28-30. (canceled)
